(19) United States
(12) Patent Application Publication
(10) Pub. No.: US 2012/0199715 A1
(43) Pub. Date: Aug. 9, 2012

(54) PORTABLE URINAL HOLDER

(76) Inventor: COLLEEN TUELL, Long Beach, WA (US)

(21) Appl. No.: 13/327,556

(22) Filed: Dec. 15, 2011

Related U.S. Application Data
(60) Provisional application No. 61/440,028, filed on Feb. 7, 2011.

(51) Int. Cl. F16M 13/00; B23P 11/00

(52) U.S. Cl. 248/311.2; 29/428

(57) ABSTRACT

A holder for a bedside urinal may include a closed loop of flexible material and a rigid spacer surrounding a portion of the closed loop. The holder may be attached to a bedrail by placing the flexible closed loop and spacer assembly around the bedrail with a first end of the loop and the spacer facing outwardly of a bed and with a second end of the loop facing inwardly of the bed. The second end may be pulled around the bed rail. The first end and spacer may be inserted through the second end and the first end may be tugged downwardly to cinch the flexible closed loop in place.

### RELATED APPLICATIONS

This application claims the benefit of U.S. Provisional Patent Application No. 61440028 filed on Feb. 7, 2011.

### BACKGROUND OF THE INVENTION

The present invention generally relates to patient care apparatus and more particularly to a device for holding or supporting a portable urinal.

In many patient care settings, such as hospitals or nursing facilities, a portable urinal may be provided to a patient for bedside use. For effective use, an empty urinal should be easily reached by the patient. Typically, the urinal may be pushed onto a bedrail. However, the urinal may fall off the bedrail.

After use, a full urinal may be placed on a bedside table. Unfortunately, this may result in a full urinal being placed near a water pitcher or a lunch tray. In some cases, the full urinal may be placed on the floor and may be easily kicked over. These urinal placement options are unsanitary, unsightly, inconvenient, and unappetizing.

As can be seen, there is a need for a system of supporting a bedside urinal in a position that allows for ease of patient access and has low risk of spillage or cross-contamination after use.

### SUMMARY OF THE INVENTION

In one aspect of the present invention, a holder for a urinal may comprise: a closed loop of flexible material; and a rigid spacer surrounding a portion of the closed loop.

In another aspect of the present invention, a method for holding a urinal at a bedside location may comprise the steps of: placing a flexible closed loop and spacer assembly around an elongated structure with a first end of the loop and the spacer facing outwardly of a bed and with a second end of the loop facing inwardly of the bed; pulling the second end around the elongated structure; inserting the first end and spacer through the second end; and tugging the first end downwardly to cinch the flexible closed loop in place.

These and other features, aspects and advantages of the present invention will become better understood with reference to the following drawings, description and claims.

### BRIEF DESCRIPTION OF THE DRAWINGS

FIG. 1 is a perspective view of a urinal holder in accordance with an embodiment of the invention;

FIG. 2 is first perspective view of the urinal holder of FIG. 1 showing an operational feature of the holder; and

FIG. 3 is second perspective view of the urinal holder of FIG. 1 showing an operational feature of the holder.

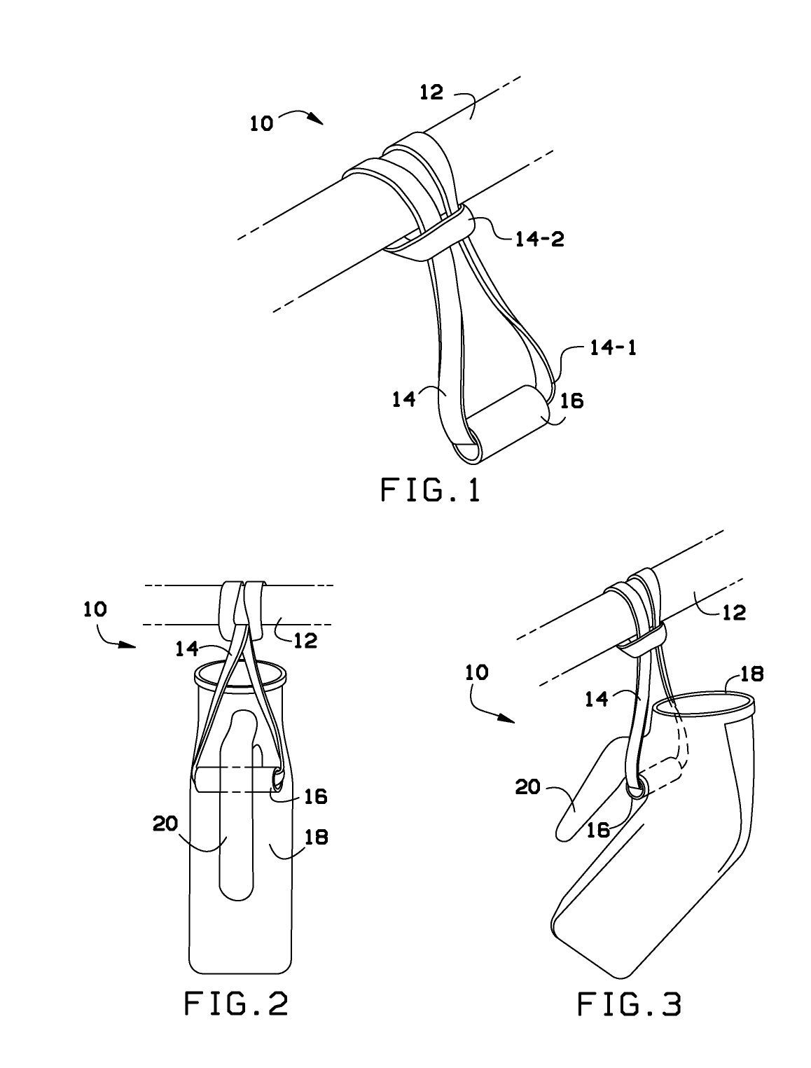

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide flexible holding assemblies for holding a urinal onto a hospital bed rail.

Referring now to the Figures, it may be seen that an exemplary embodiment of a urinal holder 10 may include a loop member 14 and a spacer 16. The loop member 14 may have a closed-loop shape and may be constructed from various materials such as cloth, plastic or closed-celled foam. For some hospital applications, a non-latex material such as closed-cell foam ethylene vinyl acetate (EVA) may be preferred because it may be non-allergenic and it may be easily wiped down if obviously soiled. Advantageously, anti-microbial material may be applied to the loop member 14.

Dimensions of the loop member 14 may vary with application. For some hospital applications, the loop member 14 may have a width of about 10 mm to about 15 mm, a thickness of about 2 mm to about 4 mm, and a length of between about 45 cm to about 60 cm.

The spacer 16 may be cylindrical in shape and may surround a portion of the loop member 14. The spacer 16 may comprise a rigid tube-shaped structure. In an exemplary embodiment, the spacer 16 may comprise a plastic tube having a wall thickness of about 1 mm to about 3 mm, an inner diameter of about 8 mm to about 15 mm and a length of about 4 cm to about 6 cm.

In operation, the flexible holding assembly 10 may be draped over an elongated structure, such as a bedrail 12, with a first end, for examples a bottom end 14-1 and the spacer 16 facing the outside and second end, for example a top end 14-2 to the inside toward the bed. The top end 14-2 may be pulled under the rail 12, and the bottom end 14-1 and spacer 16 may be inserted through the top end 14-2. The bottom end 14-1 may be tugged downward to cinch the holder 10 in place. The spacer 16 may hold the bottom end 14-1 in an open position so that an open ended handle 20 of a urinal 18 may be positioned in contact with the spacer 16. It may be seen that the urinal 18 may be easily inserted into or removed from the bottom end 14-1 of the loop member 14 because of the presence of the spacer 16. In that regard, the open bottom end 14-1 of the loop member may be considered an “easy target” for placement of the urinal handle 20 by a bedridden patient. This may also allow for ‘one-handed’ retrieval and replacement of the urinal into the holder, minimizing the need for a patient to roll or reposition in bed. Many urinals have a notch where the urinal handle attaches to the urinal body. Presence of the spacer 16 and its cylindrical shape may facilitate easy or “no snag” removal of such a urinal from the holder 10.

Whenever the urinal handle 20 is placed into the holder, irrespective of whether the urinal 18 is empty or full, gravity may adjust the angle of the hanging loop to keep the urinal 18 upright and secure. The material of the loop member 14 may be soft and flexible with enough strength to easily hold a full urinal. The soft flexible nature of the material may allow the position of the loop to adjust to the varying weights of a used urinal and gravity. The flexible nature allows for installation around the bed rail and for the assembly to maintain its position but not be a hard intrusion into the patient care area for caregivers. But the material may have a breaking point such that, if heavy medical equipment (example: x-ray machines, ultrasound machines) should catch onto the holder 10, the holder may break before other equipment does.

Advantageously, the material of the loop member 14 may have a slight stretch, without being elastic, thus allowing for a stable wrap around the rail 12, for a tighter more secure cinch around the rail 12, and for a solid, no-bounce, low-stretch placement when inserting the urinal handle 20.

It should be understood, of course, that the foregoing relates to exemplary embodiments of the invention and that modifications may be made without departing from the spirit and scope of the invention as set forth in the following claims.

What is claimed is:

1. A holder for a urinal comprising:
a closed loop of flexible material; and
a rigid spacer surrounding a portion of the closed loop.

2. The holder of claim 1 wherein the closed loop is non-allergenic.

3. The holder of claim 1 wherein the closed loop is closed-cell foam.

4. The holder of claim 3 wherein the closed loop is ethylene vinyl acetate.

5. The holder of claim 1 wherein the spacer bar is cylindrical.

6. The holder of claim 5 wherein the spacer bar has an inside diameter between about 8 mm to about 15 mm and the closed loop has a width of about 10 mm to about 15 mm.

7. The holder of claim 1 wherein the closed loop is treated with anti-microbial material.

8. The holder of claim 1 wherein the closed loop has a width of about 10 mm to about 15 mm, a thickness of about 2 mm to about 4 mm and a length of between about 45 cm to about 60 cm.

9. A method for holding a urinal at a bedside location comprising the steps of:
placing a flexible closed loop and spacer assembly around an elongated structure with a first end of the loop and the spacer facing outwardly of a bed and with a second end of the loop facing inwardly of the bed;
pulling the second end around the elongated structure;
inserting the first end and spacer through the second end; and
tugging the first end downwardly to cinch the flexible closed loop in place.

10. The method of claim 9 further comprising the step of positioning the spacer at a bottom end of the closed loop to hold the bottom end open so that an open-ended handle of the urinal can be placed over the spacer.
